(19) United States
(12) Patent Application Publication
(10) Pub. No.: US 2025/0100826 A1
(43) Pub. Date: Mar. 27, 2025

(54) MEDIUM TRANSPORT DEVICE AND MEDIUM PROCESSING SYSTEM USING THE SAME

(71) Applicant: FUJIFILM Business Innovation Corp., Tokyo (JP)

(72) Inventors: Tomokazu KURITA, Kanagawa (JP); Koichiro YUASA, Kanagawa (JP); Jun KUWABARA, Kanagawa (JP); Satoshi SHIGEZAKI, Kanagawa (JP); Hirotaka TANAKA, Kanagawa (JP); Katsumi TANAKA, Kanagawa (JP)

(73) Assignee: FUJIFILM Business Innovation Corp., Tokyo (JP)

(21) Appl. No.: 18/595,427

(22) Filed: Mar. 5, 2024

(30) Foreign Application Priority Data
Sep. 27, 2023 (JP) 2023-166482

(51) Int. Cl. B65H 5/02; G03G 15/00

(52) U.S. Cl. CPC B65H 5/023; G03G 15/6576; B65H 2301/51256; B65H 2301/5133; B65H 2301/5144

(57) ABSTRACT

A medium transport device includes: a belt-shaped first transporter configured to come into contact with one surface of a medium, and transport the medium; a belt-shaped second transporter configured to come into contact with the first transporter in an opposed manner, and transport the medium by nipping the medium in a contact area between the second transporter and the first transporter; a cooler provided in at least one of the first transporter or the second transporter, and configured to cool the medium in the contact area; and a static eliminator configured to eliminate static electricity of the medium which passes through the contact area, by applying a static elimination voltage to the first transporter or the second transporter.

### CROSS-REFERENCE TO RELATED APPLICATIONS

This application is based on and claims priority under 35 USC 119 from Japanese Patent Application No. 2023-166482 filed Sep. 27, 2023.

### BACKGROUND

### (i) Technical Field

The present disclosure relates to a medium transport device and a medium processing system using the medium transport device.

### (ii) Related Art

As the medium transport devices and medium processing systems in related art, e.g., those described in Japanese Unexamined Patent Application Publication No. 2017-090564(Detailed Description, FIG. 6), Japanese Unexamined Patent Application Publication No. 10-268666 (Detailed Description, FIG. 1), and Japanese Unexamined Patent Application Publication No. 2017-039599 (Detailed Description, FIG. 2) are already known.

Japanese Unexamined Patent Application Publication No. 2017-090564 discloses an image forming apparatus including: a static eliminator configured to eliminate static electricity of a sheet of paper after a fixing process; and a cooler provided at least one of an upward or downward position with respect to the static eliminator, and configured to cool the sheet of paper with its static electricity eliminated by the static eliminator.

Japanese Unexamined Patent Application Publication No. 10-268666 discloses a belt transfer device including an air blower configured to, when a transfer paper is separated from a transfer belt, blows airflow to a separator.

Japanese Unexamined Patent Application Publication No. 2017-039599 discloses an image forming apparatus including: a paper output tray to which a sheet of paper is output, the sheet of paper having undergone a fixing process performed by a fixing unit; an air blower configured to blow air in the apparatus onto the sheet of paper output to the paper output tray; and a static elimination unit provided between the paper output tray and the air blower, and configured to eliminate static electricity of the sheet of paper output to the paper output tray, by constant voltage control. The air blower blows at least part of the air blown to the paper output tray onto a pair of static elimination rollers of the static elimination unit, thus reduces the resistance value of the pair of static elimination rollers to increase the current value so that the static elimination performance of the static elimination unit is sustainable.

### SUMMARY

Aspects of non-limiting embodiments of the present disclosure relate to providing a medium transport device and a medium processing system using the medium transport device, which, as compared to an aspect in which when a charged medium is transported, a static elimination process is performed before a medium is cooled or after a medium is cooled, effectively prevents sticking of the medium at the time of a cooling process, and easily implements improvement of stable medium transport performance and static elimination efficiency in a simple configuration.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a medium transport device including: a belt-shaped first transporter configured to come into contact with one surface of a medium, and transport the medium; a belt-shaped second transporter configured to come into contact with the first transporter in an opposed manner, and transport the medium by nipping the medium in a contact area between the second transporter and the first transporter; a cooler provided in at least one of the first transporter or the second transporter, and configured to cool the medium in the contact area; and a static eliminator configured to eliminate static electricity of the medium which passes through the contact area, by applying a static elimination voltage to the first transporter or the second transporter.

### BRIEF DESCRIPTION OF THE DRAWINGS

Exemplary embodiments of the present disclosure will be described in detail based on the following figures, wherein:

FIG. 1A is an explanatory view illustrating an outline of an exemplary embodiment of a medium processing system including a medium transport device to which the present disclosure is applied, and FIG. 1B is an explanatory view illustrating the structure of the surroundings of an ejector of the medium transport device in FIG. 1A;

FIG. 2 is an explanatory view illustrating the entire configuration of a medium processing system according to a first exemplary embodiment;

FIG. 3 is an explanatory view illustrating a primary part of a medium transport system in a subsequent stage of a transfer unit of the medium processing system illustrated in FIG. 2;

FIG. 4 is an explanatory view illustrating the detail of the surroundings of a cooling device according to the first exemplary embodiment;

FIG. 5A is an explanatory view illustrating a configuration example of an ejector of the cooling device, and FIG. 5B is an explanatory view illustrating a configuration example of a steering mechanism of the cooling device;

FIG. 6 is a flowchart illustrating a control process for the cooling device according to the first exemplary embodiment;

FIG. 7 is an explanatory view illustrating the effect of the cooling device according to the first exemplary embodiment;

FIG. 8 is an explanatory graph illustrating a relationship between electrical resistance and relative humidity;

FIG. 9A is an explanatory view illustrating the behavior of the ejector when the ejection angle θ of the medium is zero, FIG. 9B is an explanatory view illustrating the behavior of the ejector when the ejection angle θ is negative (−), and FIG. 9C is an explanatory view illustrating the behavior of the ejector when the ejection angle θ is positive (+);

FIG. 10 is an explanatory view illustrating a primary part of the surroundings of a cooling device according to a second exemplary embodiment;

FIG. 11 is an explanatory table illustrating a relationship between medium type and ejection angle of a medium at a cooling device ejector in the cooling device according to the second exemplary embodiment;

FIG. 12A is an explanatory view illustrating a configuration example of the ejector of the cooling device according to the second exemplary embodiment, and FIG. 12B is an arrow view as seen in B direction in FIG. 12A;

FIG. 13 is an explanatory view illustrating a primary part of a cooling device according to a third exemplary embodiment;

FIG. 14A is an explanatory view illustrating a configuration example of a curl correction mechanism, FIG. 14B is an explanatory view illustrating the behavior of the curl correction mechanism, FIG. 14C is an explanatory view illustrating the behavior of the curl correction mechanism when the leading edge of the medium is curled upward, and FIG. 14D is an explanatory view illustrating the behavior of the curl correction mechanism when the leading edge of the medium is curled downward;

FIG. 15 is an explanatory view illustrating the detail of the surroundings of a cooling device according to a fourth exemplary embodiment;

FIG. 16A is a graph illustrating a relationship between the thickness t of medium and the ejection angle θ of medium, the relationship allowing a separation operation to be stably performed on the medium from the ejector in the condition that the feed velocity of the medium is 250 mm/s in the cooling device according to the first exemplary embodiment, and FIG. 16B is a graph illustrating a relationship between the thickness t of medium and the ejection angle θ of medium, the relationship allowing a separation operation to be similarly performed as in FIG. 16A in the condition that the feed velocity of the medium is 500 mm/s.

### DETAILED DESCRIPTION

### Overview of Exemplary Embodiment

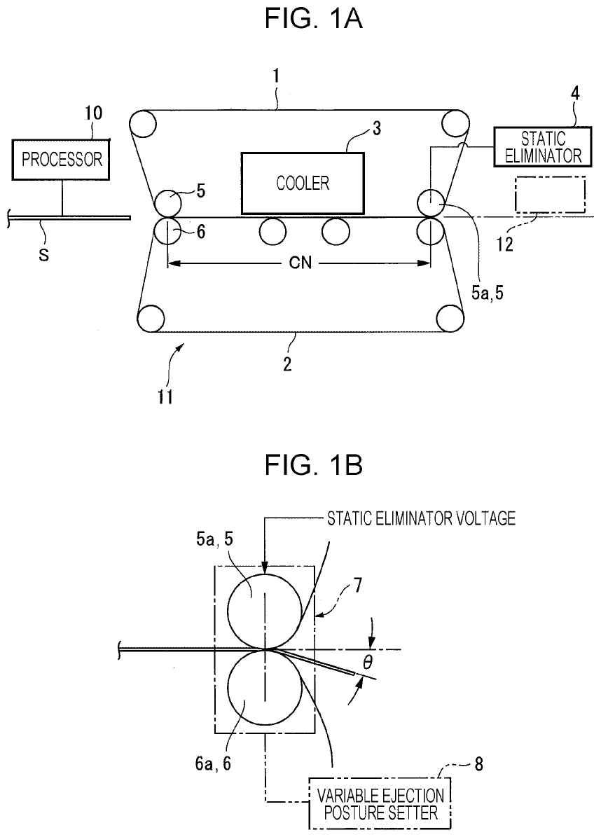

FIG. 1A illustrates a schematic view of an exemplary embodiment of a medium processing system including a medium transport device to which the present disclosure is applied.

In FIG. 1A, the medium processing system includes a processing unit 10 that performs a process associated with charging on a moving medium S; and a medium transport device 11 provided downstream of the processing unit 10 in the movement direction of the medium S, and configured to cool the medium S while eliminating static electricity of the medium S by allowing the medium S to pass through.

Here, as the processing unit 10, for example, a processing unit may be mentioned, which includes an image generator configured to generate an image on an image carrier, and transfer the generated image to the medium S using a transfer electric field; and a fixing unit configured to heat and fix the image transferred to the medium S.

The medium transport device 11 includes: a belt-shaped first transporter 1 that is to come into contact with one surface of the medium S and configured to transport the medium S; a belt-shaped second transporter 2 that is to come into contact with the first transporter 1 in an opposed manner, and configured to transport the medium S by nipping the medium S in contact area CN between the second transporter 2 and the first transporter 1; a cooler 3 provided in at least one of the first transporter 1 or the second transporter 2, and configured to cool the medium S in the contact area CN; and a static eliminator 4 configured to eliminate static electricity of the medium S which passes through the contact area CN, by applying a static elimination voltage to the first transporter 1 or the second transporter 2.

In these technical components, the medium processing system may include the processing unit 10 and the medium transport device 11 in one device housing, or a device including the processing unit 10, and a device including the medium transport device 11 may be disposed adjacently as separate unit configurations.

It is assumed that the medium transport device 11 has an aspect in which the first transporter 1, the second transporter 2 are cach belt-shaped, and one of the transporters is provided with at least the cooler 3, and medium transport device 11 additionally has a static elimination function. Thus, a cooling device having a cooling function, and a static elimination device having a static elimination function do not need to be provided separately although in an example in related art, a cooling function, and a static elimination function for a medium are performed by different devices for transporting the medium.

It is sufficient that the cooler 3 be provided in at least one of the first transporter 1 or the second transporter 2. When one (e.g., the first transporter 1) of the transporters is provided with the cooler 3, the other transporter (e.g., the second transporter 2) not provided with the cooler 3 is indirectly cooled through the contact area CN when the medium S is not passing.

Furthermore, as the cooler 3, typically, a heat sink disposed on the rear surface of the contact area CN of the first transporter 1 or the second transporter 2 may be mentioned; however, without being limited to this, an area (either the rear surface or the front surface is allowed) other than the contact area CN of the first transporter 1 or the second transporter 2 may be cooled. In this case, as the cooler 3, for example, a cooling element (such as a Peltier device) may be incorporated in a stretching member 5 or 6 of the first transporter 1 or the second transporter 2, and the stretching member 5 or 6 may also serve as the cooler 3.

Furthermore, since the cooler 3 used in this example has a requirement that is “to cool the medium S in the contact area CN”, this example does not have an aspect in which the medium S which has not entered the contact area CN is cooled by blowing air to the medium S.

As the static eliminator 4, a static eliminator may be selected as appropriate as long as the static eliminator applies a static elimination voltage to the first transporter 1 or the second transporter 2. In this case, a static elimination voltage may be directly applied to the first transporter 1 or the second transporter 2. Alternatively, a stretching member or an electrode member for the first transporter 1 or the second transporter 2 may be separately provided, and a static elimination voltage may be applied to the stretching member or electrode member so that the static elimination voltage is applied to the first transporter 1 or the second transporter 2 via the stretching member or electrode member.

Furthermore, the static eliminator 4 in this example eliminates static electricity of the medium S while cooling the medium S. With the same absolute humidity, when the temperature is lowered, the relative humidity increases, thus static electricity tends to be scattered in a short time. Thus, the static elimination effect achieved by the static eliminator 4 is promoted.

Next, a typical aspect or an exemplary aspect of the medium transport device according to the exemplary embodiment will be described.

First, in a typical aspect of the cooler 3, the cooler 3 cools the rear surface of the contact area CN of the first transporter 1 or the second transporter 2. This aspect is comprised of, e.g., a heat radiator (such a heat sink) that comes into contact with the rear surface of the contact arca CN.

As an exemplary aspect of the cooler 3, an aspect may be mentioned in which a variable cooler (not illustrated) is provided, which sets a variable degree of cooling for the medium S which passes through the contact area CN. This example is exemplary in that even if the heating state of the medium S varies due to change in an ambient environment or process conditions for the medium S, the degree of cooling can be adjusted appropriately according to the heating state of the medium S.

As a typical aspect of the static eliminator 4, an aspect may be mentioned in which as illustrated in FIG. 1B, a static elimination voltage is applied to a stretching member 5a which is one of the stretching member 5 of the first transporter 1 (or a stretching member 6a which is one of the stretching member 6 of the second transporter 2) so that the static elimination voltage is applied to the first transporter 1 (or the second transporter 2). This example is effective in that the stretching member 5 or 6 of the first transporter 1 or the second transporter 2 is utilized as an electrode member, and another electrode member does not need to be separately provided.

Particularly, from the viewpoint that the static eliminator 4 is operated at a timing when the medium S enters the contact area CN, a drive stretching member may be used as the stretching member 5a (or 6a) to which a static elimination voltage is applied.

In this example, from the viewpoint of eliminating the effect on an entry operation of the medium S to the contact area CN, in an exemplary aspect, as the stretching member 5a (or 6a) to which a static elimination voltage is applied, a stretching member located at an exit of the contact area CN in a movement direction of the medium S may be used.

As an exemplary aspect of the static eliminator 4, an aspect may be mentioned in which the polarity and output value of the static elimination voltage are variably set. This example is effective for performing a static elimination operation suitable for the charge state of the medium S because the charge state of the medium S varies.

In particular, in order to identify the charge state of the medium S in advance, for example, a detector (not illustrated) may be provided, which detects the charge state (charged polarity, charge amount) of the medium S before entering the contact area CN, and the polarity and output value of the static elimination voltage may be variably set depending on a detection result of the detector.

Since the charge state of the medium S also depends on the type and characteristic information (such as a thickness, a resistance value) of the medium S, a determination unit (not illustrated) may be provided, which determines the characteristic information of the medium S before entering the contact area CN, and the polarity and output value of the static elimination voltage can be variably set depending on a result of determination by the determination unit.

The material characteristics of the first transporter 1 or the second transporter 2 may be selected as appropriate, however, from the viewpoint of favorably maintaining the static elimination performance at the contact area CN, in an exemplary aspect, the first transporter 1 and the second transporter 2 are comprised of a conductive member having a volume resistivity of 11 LogΩ·cm or lower in a voltage application condition of 500 V/thickness of 100 μm.

Alternatively, the first transporter 1 and the second transporter 2 may be provided with another function. For example, in order to provide a curl correction function, for the first transporter 1 and the second transporter 2, an entry to the contact area CN in a movement direction of the medium S may be deformed to a shape by which curl of the medium S is correctable, and disposed.

Furthermore, as an exemplary aspect of the first transporter 1 and the second transporter 2, an aspect may be mentioned in which as illustrated in FIG. 1B, an ejector 7 comprised of a pair of stretching members 5a, 6a is provided at an exit of the contact area CN in a movement direction of the medium S, and the ejector is provided with a variable ejection posture setter 8 that is configured to variably set an ejection angle θ of the medium S with respect to a predetermined reference line.

As a typical aspect of the variable ejection posture setter 8, an aspect may be mentioned, in which a determination unit (not illustrated) may be provided, which determines the characteristic information of the medium S before entering the contact area CN, and the ejection angle θ of the medium S is variably set depending on a result of determination by the determination unit.

As an exemplary aspect of the first transporter 1 and the second transporter 2, an aspect may be mentioned in which a variable velocity setter (not illustrated) is provided, which is configured to variably set the transport velocity of the medium S which passes through the contact area CN. This example is effective in that even if the heating state and the charge state of the medium S varies, the medium S can be appropriately cooled, and the static electricity thereof can be eliminated by adjusting the cooling time and the static elimination time.

Furthermore, from the viewpoint of strengthening the static elimination effect on the medium S, in an exemplary aspect, a non-contact static eliminator (not illustrated) is provided downstream of an exit of the contact area CN in a transport direction of the medium S. The non-contact static eliminator referred to herein indicates an eliminator that is disposed in a non-contact state with the medium S ejected from the contact area CN, and is configured to further eliminate static electricity of the medium S by corona discharge obtained by applying a discharge voltage to a discharge electrode, the discharge voltage including at least an alternating-current component.

### FIRST EXEMPLARY EMBODIMENT

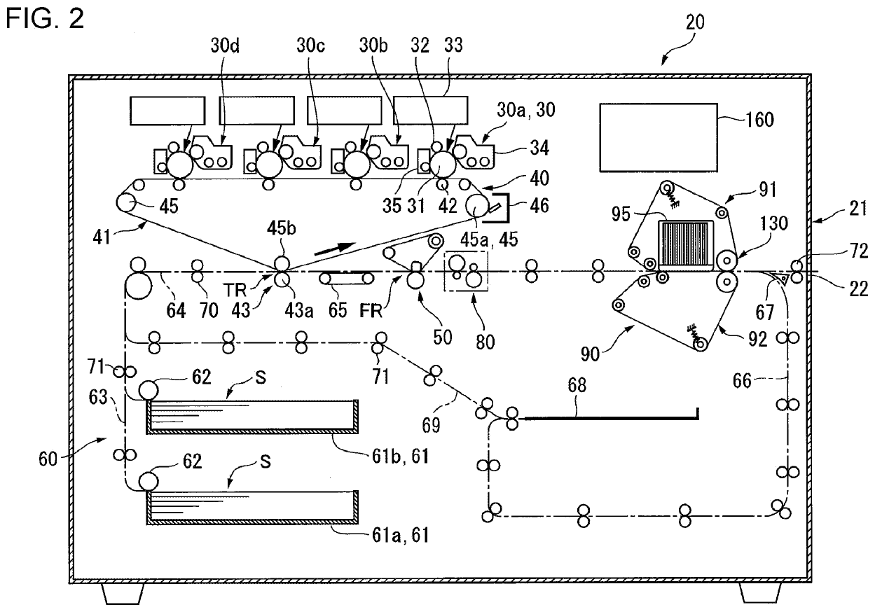

Hereinafter, the present disclosure will be described in greater detail based on the exemplary embodiment illustrated in the accompanying drawings. FIG. 2 illustrates the entire configuration of a medium processing system according to a first exemplary embodiment.

### Entire Configuration of Medium Processing System

In this exemplary embodiment, a medium processing system 20 is an image forming system that forms an image on medium S and ejects the image. In a housing 21, the medium processing system 20 stores: a plurality of (four in this example) image formers 30 that form an image of cach color (four colors: yellow (Y), magenta (M), cyan (C), and black (K) in this example); a transfer device 40 that transfers the image formed by the image former 30; a fixing device 50 that fixes an unfixed image transferred to the medium S by the transfer device 40; and a medium transport system 60 that transports the medium S to processing units such as the transfer device 40, and the fixing device 50.

### Image Former

In this example, the image formers 30 (specifically, 30a to 30d) adopt an electrophotographic system, and cach includes e.g.: a drum-shaped photoconductor 31; a charging device 32 that charges the surface of the photoconductor 31 to a predetermined potential; an exposure device 33 that exposes, based on image data, the photoconductor 31 charged by the charging device 32 to write an electrostatic latent image; a developing device 34 that develops the electrostatic latent image formed on the photoconductor 31 with color component toner; and a cleaning device 35 that cleans the residual toner on the photoconductor 31 after transfer.

Note that an electrophotographic system is adopted in this example, however, without being limited to this, a dielectric may be used instead of the photoconductor 31, and a method of writing an electrostatic latent image on the dielectric by a latent image writing device, such as an ion flow writing device, may be used.

### Transfer Device

For the transfer device 40, a direct transfer method may be adopted, by which an image (color component image) composed of color component toner, formed by each image former 30 is directly transferred to the medium S. In this example, an indirect transfer method is adopted.

In this example, the transfer device 40 is disposed to be opposed to the photoconductor 31 of each image former 30 movably in circulation, and includes e.g.: a belt-shaped intermediate transfer body 41 that transfers and maintains cach color component image formed on the photoconductor 31; first transfer units 42 that are disposed on the rear surface of the intermediate transfer body 41 opposed to each photoconductor 31, and configured to first transfer the color component image on the photoconductor 31 onto the intermediate transfer body 41; and a second transfer unit 43 that collectively transfers (secondly transfers), to the medium S, color component images superimposed and transferred onto the intermediate transfer body 41.

In this example, a belt-shaped intermediate transfer body 41 is stretched over a plurality of stretching rollers 45, and driven, for example, by one (45a) of the stretching rollers 45 as a drive roller movably in circulation. The first transfer unit 42 includes e.g., a first transfer roller disposed on the rear surface of the intermediate transfer body 41 opposed to the photoconductor 31, and configured to form a first transfer electric field for image transfer by applying a predetermined first transfer bias to the first transfer roller. Furthermore, the second transfer unit 43 includes e.g., a second transfer roller 43a that is disposed at a position on the surface of the intermediate transfer body 41 and opposed to one (45b) of the stretching rollers 45, and configured to form a second transfer electric field for image transfer at a second transfer arca TR between the second transfer roller 43a and the stretching roller 45b by applying a predetermined second transfer bias to the stretching roller 45b opposed to the second transfer roller 43a.

In this example, a corona discharger such as a corotron, a scorotron may be used for the first transfer unit 42 and the second transfer unit 43. In consideration of transportability of the medium S, a transfer belt stretched over the transfer roller may be used as the second transfer unit 43.

Note that symbol 46 indicates an intermediate transfer body cleaning device that cleans residual toner on the intermediate transfer body 41.

### Fixing Device

For the fixing device 50, a heating and pressurizing method or a heating method may be selected as appropriate as the fixing method regardless of a contact or a non-contact method as long as the fixing device fixes an unfixed image on the medium S.

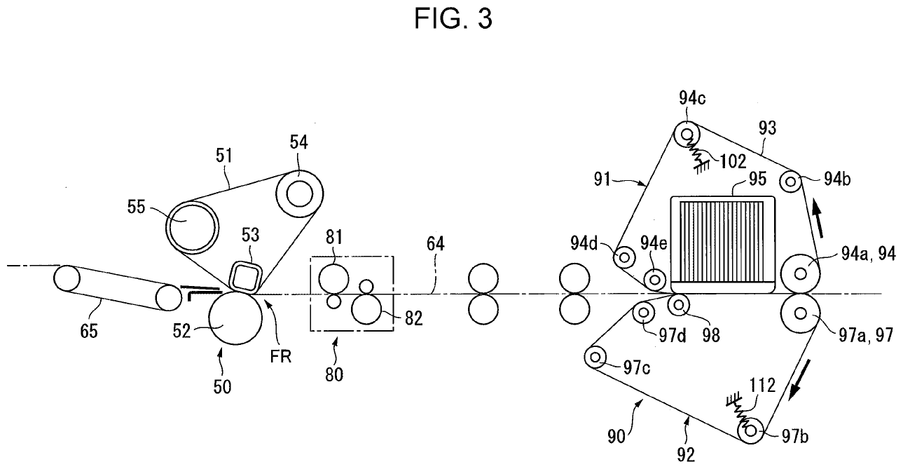

In this example, the fixing device 50 which has adopted a contact heating and pressurizing method is used. As illustrated in FIG. 2 and FIG. 3, the fixing device 50 includes: a fixing belt 51 made of a heat resistant material, which moves in a circulating manner; a pressure roller 52 disposed in contact with the surface area opposed to the fixing area of the fixing belt 51; a pressure pad 53 as a pressure member that is disposed in contact with the rear surface of the fixing belt 51 opposed to the pressure roll 52, and configured to form a fixing arca FR for transporting the medium S by nipping the medium S between the pressure roller 52 and the fixing belt 51; a heating roller 54 that stretches the fixing belt 51 movably in circulation upstream of the fixing area FR of the fixing belt 51 in a movement direction, and configured to come into contact with and heat the fixing belt 51; and a stretching roller 55 that stretches the fixing belt 51 movably in circulation downstream of the fixing area FR of the fixing belt 51 in a movement direction.

As the fixing belt 51, a fixing belt may be selected as appropriate provided that the fixing belt uses a resin material having a heat resistance property, e.g., polyimide (PI) resin as the base material, and an elastic layer such as silicon rubber is laminated and a release layer made of a fluorine-based resin is laminated on the surface of the base material.

As the pressure roller 52, a roller is used in which an elastic material such as urethane rubber is laminated around a metal roller, and a protective layer is laminated on the surface of the clastic material.

In addition, the pressure pad 53 serves as a receiving member disposed in contact with the rear surface of the fixing belt 51, and includes a plate-like pad body composed of liquid crystal polymer or the like, and a substantially rectangular holder comprised of a hollow pipe, which holds the pad body.

The heating roller 54 has a built-in heat source such as a halogen lamp within its roller body, and both shaft ends of the roller body are rotatably held by bearings which are not illustrated. The heating roller 54 transmits heat to the fixing belt 51 by bringing the circumferential surface of the roller body into contact with the rear surface of the fixing belt 51 to heat the fixing belt 51, and serves the fixing process in the fixing area FR.

Furthermore, in this example, the heating roller 54 is configured to serve as a drive roller for rotationally moving the fixing belt 51. Thus, in this example, the pressure roller 52 is configured to be driven to rotate by the fixing belt 51 at the fixing arca FR.

Note that as the heating roller 54, a heating roller may be configured in which instead of a heat source such as a halogen lamp, a heat generation resistive layer is formed, e.g. in the roll body with an insulating layer interposed therebetween so as to heat the heat generation resistive layer.

The stretching roller 55 may be a roller that stretches the fixing belt 51 movably in circulation; however, from the viewpoint of maintaining the tension of the fixing belt 51, the stretching roller 55 may serve as a tension roller for applying tension. When the amount of heating to the fixing belt 51 needs to be increased, a heat source may be incorporated in the stretching roller 55 or the above-mentioned pressure pad 53.

Note that in this example, the fixing device 50 adopts a method that uses the fixing belt 51, however, without being limited to this, an aspect may be selected as appropriate in which the heating roller and the pressure roller are disposed to be opposed to each other.

### Medium Transport System

In this example, as illustrated in FIG. 2, the medium transport system 60 includes multi-stage (two stages in this example) medium supply containers 61 (61a, 61b), and configured to transport medium S from a vertical transport path 63 extending in a substantially vertical direction to a horizontal transport path 64 extending in a substantially horizontal direction, the medium S being supplied from one of the medium supply containers 61 by a feeder 62. The horizontal transport path 64 reaches the second transfer area TR, and subsequently, allows the medium S with a transferred image to transport to the fixing area of the fixing device 50 through the transport belt 65, and allows the medium S after fixing to be ejected from an ejection port 22 of the housing 21 to a laterally-provided medium ejection receiver which is not illustrated.

The medium transport system 60 includes a branch transport path 66 that branches off down from an area located downstream of the fixing device 50 on the horizontal transport path 64 in the medium transport direction, and is provided with a switching gate 67 for transport path switching at the boundary between the horizontal transport path 64 and the branch transport path 66. In the middle of the branch transport path 66, the medium transport system 60 includes a reverser 68 where the medium S is reversable, and is configured to return the medium S reversed by the reverser 68 from the vertical transport path 63 to the horizontal transport path 64 again through a return transport path 69. Thus, the medium transport system 60 is configured to transport the reversed medium S to the second transfer area TR, transfer an image to the rear surface of the medium S at the second transfer area TR, and eject the medium S to a medium ejection receiver (not illustrated) through the fixing device 50.

In the medium transport system 60, alignment rollers 70 that align the leading edge position of the medium S and supply the medium S to the second transfer area TR are provided, and additionally, an appropriate number of transport rollers 71 are provided in transport paths 63, 64, 66, 69, and the periphery of the ejection port 22, serving as the exit of the horizontal transport path 64, of the housing 21 is provided with ejection rollers 72 to eject the medium S to a medium ejection receiver which is not illustrated.

### Curl Correction Device

In this exemplary embodiment, as illustrated in FIG. 2 and FIG. 3, a curl correction device 80 is provided downstream of the fixing device 50 on the horizontal transport path 64 in the medium transport direction. Since the medium S which has passed through the fixing area FR of the fixing device 50 tends to curl in a fixing process by heating and pressurization, the curl correction device 80 is designed to correct the curl of the medium S. The curl that occurs in the medium S includes down curl in which the leading edge of the medium S in the transport direction curls downward with respect to the transport direction, and upper curl in which the leading edge of the medium S in the transport direction curls upward with respect to the transport direction. Thus, in this example, the curl correction device 80 includes a first curl corrector 81 that primarily corrects down curl, and a second curl corrector 82 that primarily corrects upper curl. Note that as the first curl corrector 81, e.g. upper and lower pressure rollers in a pair configuration with a smaller diameter on down curl side are used. As the second curl corrector 82, e.g. upper and lower pressure rollers in a pair configuration with a smaller diameter on upper curl side are used.

### Cooling Device

### <Necessity of Cooling Device>

In general, when the medium S, which has passed through the fixing area FR of the fixing device 50, is ejected in a high temperature state, there is a possibility that an image composed of toner is transformed into a melted state due to heat, and stacked media S are likely to stick to each other.

In this exemplary embodiment, as illustrated in FIG. 2 and FIG. 3, the cooling device 90 (corresponding to the medium transport device 11 in FIG. 1) is provided downstream of the curl correction device 80 on the horizontal transport path 64 in the medium transport direction. The cooling device 90 cools the medium S which has passed through the fixing area FR of the fixing device 50, and cools an image composed of toner fixed to the medium S, thereby preventing a melted state of the image due to heat.

### <Basic Configuration Example of Cooling Device>

As illustrated in FIG. 2 to FIG. 4, in an overall view, the cooling device 90 includes an upper unit 91 disposed above, and a lower unit 92 disposed below. The upper unit 91 includes: a first transport belt 93 that moves in a circulating manner as an endless first transporter; a plurality of (five in this example) stretching rollers 94 (specifically, 94a to 94c) that stretch the first transport belt 93 with necessary tension applied; and a heat sink 95 serving as a cooler disposed on the inner circumferential side of the first transport belt 93.

The lower unit 92 includes: a second transport belt 96 that moves in a circulating manner as an endless second transporter; a plurality of (four in this example) stretching rollers 97 (specifically, 97a to 97d) that stretch the second transport belt 96 with necessary tension applied; and a pressing roller 98 serving as a pressing member disposed on the inner circumferential side of the second transport belt 96, and configured to press the second transport belt 96 against the heat sink 95 with the first transport belt 93 interposed therebetween.

### <Components of Upper Unit>

In this example, as the first transport belt 93, e.g. an endless belt made of synthetic resin material such as polyimide is used. In this case, the volume resistance of the first transport belt 93 may be selected as appropriate, and in this example, a conductive member having a volume resistivity of 11 LogΩ·cm or lower in a voltage application condition of 500 V/thickness of 100 μm is implemented by mixing an appropriate amount of conductive agent in the synthetic resin material.

The stretching roller 94a disposed near a downstream position of the heat sink 95 of the plurality of stretching rollers 94 in the belt movement direction is formed as a drive roller for moving the first transport belt 93 in a circulating manner. The stretching roller 94a as the drive roller is driven to rotate by transmitting the driving force of a drive motor 100 via a drive transmission mechanism 101. The stretching rollers 94b, 94d, 94e are each formed as a driven roller for maintaining the running position of the first transport belt 93. The stretching roller 94c is formed as a tension applying roller for applying necessary tension to the first transport belt 93 by a biasing spring 102.

The heat sink 95 is disposed in contact with the inner circumferential surface of the first transport belt 93 in an area of the first transport belt 93, the area bridging between the stretching rollers 94a and 94c. The stretching rollers 94a and 94e are disposed above the lower end surface of the heat sink 95, and the first transport belt 93 is disposed in contact with the lower end surface of the heat sink 95 due to the tension of the first transport belt 93. The heat sink 95 is formed of a material having a thermal conductivity higher than that of the first transport belt 93, and is formed of e.g. a metal material such as aluminum. Note that the heat sink 95 includes, at its lower end, a base plate 951 to come into contact with the first transport belt 93. The lower end surface of the heat sink 95 is formed in a curved shape having a large radius of curvature so as to be planar or convex downward. In addition, the upstream and downstream ends of the base plate 951 in the belt movement direction each have a curved shape having a small radius of curvature.

In the heat sink 95, multiple radiator plates 952 formed in a thin plate-like shape are disposed on the upper end surface of the base plate 951 in the belt width direction crossing the belt movement direction, and are disposed in contact with the base plate 951 with necessary intervals in the belt movement direction. The back surface side (corresponding to the depth side in the direction perpendicular to the drawing) of the heat sink 95 in the belt width direction is provided with a blower 105 as a suction unit. The blower 105 is driven to rotate when the cooling device 90 is operated, and the air sucked from the near side (corresponding to the near side in the direction perpendicular to the drawing) of the housing 21 is ejected to the back surface side, thus the air flow is brought into contact with the radiator plates 952 to radiate heat from the radiator plates 952.

### <Components of Lower Unit>

In the same manner as the first transport belt 93, e.g. an endless belt made of synthetic resin material such as polyimide is used as the second transport belt 96. In this case, the volume resistance of the second transport belt 96 may be selected as appropriate, and in this example, a conductive member having a volume resistivity of 11 LogΩ·cm or lower in a voltage application condition of 500 V/thickness of 100 μm is implemented by mixing an appropriate amount of conductive agent in the synthetic resin material.

The stretching roller 97a of the plurality of stretching rollers 97 is formed as a drive roller for moving the second transport belt 96 in a circulating manner. The stretching roller 97a as the drive roller is driven to rotate by transmitting the driving force of a drive motor 110 via a drive transmission mechanism 111. The stretching roller 97a is disposed to be opposed to the stretching roller 94a of the first transport belt 93, and is in pressure contact with the stretching roller 94a. The stretching rollers 97c, 97d are each formed as a driven roller for maintaining the running position of the second transport belt 96. The stretching roller 97b is formed as a tension applying roller for applying necessary tension to the second transport belt 96 by a biasing spring 12.

The pressing roller 98 is disposed at an end side of the heat sink 95 so as to press the second transport belt 96 against the heat sink 95 with the first transport belt 93 interposed therebetween, the end side at which the first transport belt 93 starts to be in contact with the heat sink 95. In this example, the pressing roller 98 is disposed at the upstream end of the heat sink 95 in the movement direction of the first transport belt 93.

The pressing roller 98 is formed, for example, by covering an elastic layer around the outer circumference of a metal core over a needed thickness in an axial direction, the elastic layer having needed rubber hardness. The pressing roller 98 is pressed against the heat sink 95 with a needed pressure load by elastic members such as a compression spring disposed at both ends of the metal core. Note that the pressing member is not limited to the pressing roller 98, and a pressing member comprised of a fixed roller body, a film-like member or a pad-like member may be used.

Like this, in this example, the cooling device 90 includes a contact area Re between the first transport belt 93 and the second transport belt 96, the contact area Re corresponding to the area between the stretching roller 97a of the second transport belt 96 and the pressing roller 98. In addition, contact area Rc in the contact area Re serves as a cooling area for exerting a cooling effect on the medium S, the contact area Rc corresponding to the area where the heat sink 95 is in contact with the inner circumferential surface of the first transport belt 93. The downstream exit of the contact area Re in the belt movement direction, that is, a nip (clamper) between the stretching roller 94a as the drive roller of the first transport belt 93 and the stretching roller 97a as the drive roller of the second transport belt 96 serves as an ejector 120 for the medium S from the cooling device 90.

### Additional Function of Cooling Device

### <Configuration Example of Static Eliminator>

In this exemplary embodiment, the cooling device 90 includes a static eliminator 130 as a static eliminator at the contact area Re between the first transport belt 93 and the second transport belt 96, the static eliminator being configured to eliminate static electricity of the moving medium S.

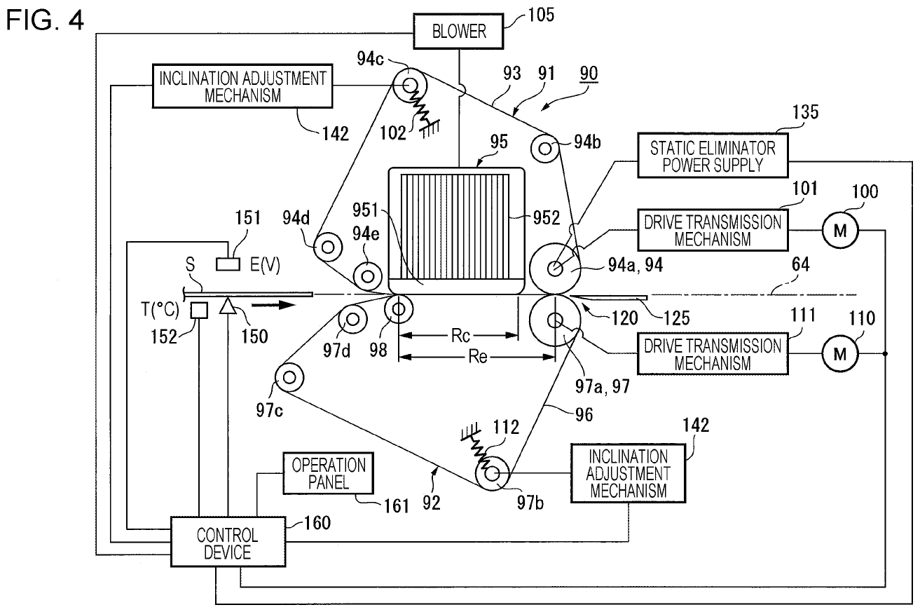

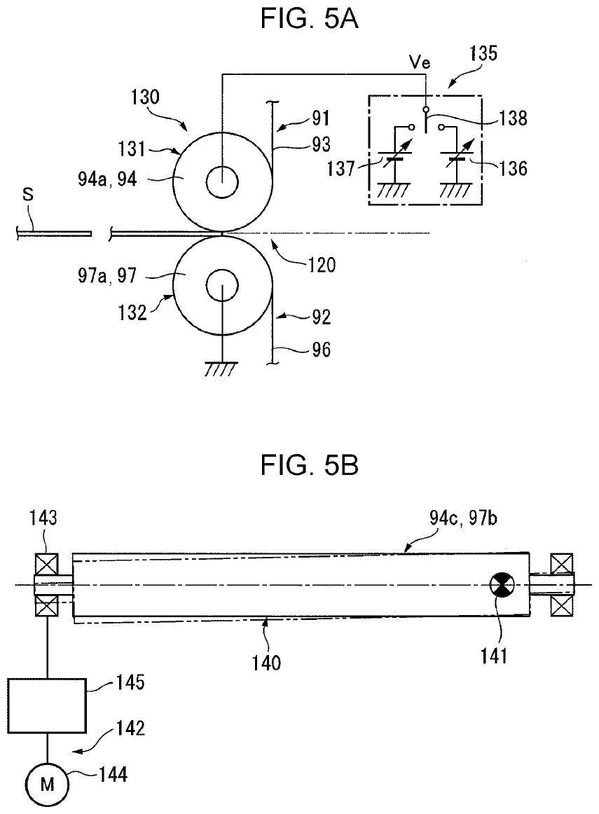

As illustrated in FIG. 4 and FIG. 5A, the static eliminator 130 includes the stretching roller 94a of the first transport belt 93 and the stretching roller 97a of the second transport belt 96 which also serve as static elimination rollers 131, 132 in a pair configuration. In this example, a rotational shaft end of the static elimination roller 131, which also serves as the stretching roller 94a, is coupled to a static elimination power supply 135. In contrast, the static elimination roller 132, which also serves as the stretching roller 97a, is grounded.

In this example, the static elimination power supply 135 includes: a negative polarity power supply 136 that applies a negative polarity static elimination bias Ve (−) in a variably adjustable manner; a positive polarity power supply 137 that applies a positive polarity static elimination bias Ve (+) in a variably adjustable manner; and a switching device 138 that switches to one of the negative polarity power supply 136 or the positive polarity power supply 137 or power supply off.

### <Configuration Example of Steering Function>

In this exemplary embodiment, the stretching roller 94c of the first transport belt 93 is configured to serve as a tension applying roller as well as a steering roller 140. The steering roller 140 is configured to, when the first transport belt 93 meanders in the width direction, adjust an inclined posture of the first transport belt 93 to prevent the meandering of the first transport belt 93.

In this example, as illustrated in FIG. 4 and FIG. 5B, the stretching roller 94c is supported swingably around a predetermined swing point 141, and configured to adjust an inclined posture by an inclination adjustment mechanism 142.

The swing point 141 may be provided at any position of the stretching roller 94c in an axial direction, and in this example, the swing point 141 is provided near one end of the stretching roller 94c in an axial direction. The inclination adjustment mechanism 142 moves a bearing 143 for a rotary shaft on the side away from the swing point 141 of the stretching roller 94c in a direction crossing the axial direction, and swings the stretching roller 94c around the swing point 141 to adjust the inclined posture of the stretching roller 94c. As the inclination adjustment mechanism 142, a mechanism may be mentioned, which rotates an eccentric cam 145 by a predetermined amount with e.g., a drive motor 144 to change the swing amount of the stretching roller 94c.

Note that the stretching roller 97b of the second transport belt 96 is configured to serve as a tension applying roller as well as the steering roller 140.

### Surrounding Structure of Cooling Device

In this example, the surrounding structure of the cooling device 90 is constructed, for example, as illustrated in FIG. 4.

### <Position Sensor>

In this exemplary embodiment, a position sensor 150 is provided upstream of the cooling device 90 on the horizontal transport path 64 in the transport direction of the medium S. The position sensor 150 detects e.g. a timing when the leading edge of the medium S passes in the transport direction.

### <Surface Potential Sensor>

In this exemplary embodiment, a surface potential sensor 151 is provided upstream of the cooling device 90 on the horizontal transport path 64 in the transport direction of the medium S. The surface potential sensor 151 detects the charge state (polarity, charge amount) of the medium S which has passed through the second transfer area TR of the second transfer unit 43.

### <Environmental Sensor>

In this exemplary embodiment, a temperature sensor 152 serving as an environmental sensor is provided, which detects the atmospheric temperature in the housing 21.

### <Guide Chute>

In this exemplary embodiment, as illustrated in FIG. 4, immediately after the ejector 120 of the cooling device 90 on the horizontal transport path 64, a plate-like guide chute 125 is provided, which guides the medium S ejected from the ejector 120. The guide chute 125 is disposed slightly below an extension surface extended from the contact area Re of the cooling device 90 in the movement direction of the medium S, and a minute gap (e.g. approximately 1 mm) is provided between the guide chute 125 and the ejector 120.

### Control System for Cooling Device

In this example, as illustrated in FIG. 4, a control system for the cooling device includes a control device 160 comprised of a microcomputer including various processors. In the embodiments above, the term “processor” refers to hardware in a broad sense. Examples of the processor include general processors (c.g., CPU: Central Processing Unit) and dedicated processors (c.g., GPU: Graphics Processing Unit, ASIC: Application Specific Integrated Circuit, FPGA: Field Programmable Gate Array, and programmable logic device).

The control device 160 is coupled to an operation panel 161 of the medium processing system 20, and various detectors such as the position sensor 150, the surface potential sensor 151, and the temperature sensor 152. From the control device 160, proper control signals are to be output to the targets to be controlled (such as the drive motors 100, 110, the blower 105, the static elimination power supply 135, and the inclination adjustment mechanism 142).

Note that the operation panel 161 is provided with a start switch (not illustrated) to start an image forming process for the medium S, and a mode switch (not illustrated) to specify an image generation mode, such as single-sided printing, double-sided printing, or high-definition printing.

### Operation of Medium Processing System

The basic operation of the medium processing system 20 will be described.

<Process before Passing through Cooling Device>

First, the case where a mode for forming an image on one side of the medium S is performed will be described as an example. In the medium processing system 20, when single-sided color printing mode is specified, and the start switch (not illustrated) is turned on, images (color component images) composed of color component toner are formed on the photoconductors 31 using the four image formers 30 (30a to 30d).

Thereafter, the color component images of the photoconductors 31 are cach first transferred to the intermediate transfer body 41 of the transfer device 40 by the respective first transfer units 42. Note that residual substances such as residual toner on the photoconductors 31 are cleaned by the cleaning device 35. The color component images held on the intermediate transfer body 41 are transported to the second transfer area TR by the rotation of the intermediate transfer body 41.

In contrast, in the medium transport system 60, the medium S is supplied from one of the medium supply containers 61 (61a, 61b) by the feeder 62, and is transported to the alignment rollers 70 through the vertical transport path 63 and the horizontal transport path 64, and aligned by the alignment rollers 70, then transported to the second transfer arca TR.

In the second transfer area TR, the second transfer unit 43 collectively secondly transfers the color component images on the intermediate transfer body 41 to the medium S. Note that residual substances such as residual toner and paper dust on the intermediate transfer body 41 after the second transfer are cleaned by an intermediate transfer body cleaning device 46.

Subsequently, as illustrated in FIG. 3, the medium S with the secondly transferred color component images reaches the fixing device 50 through the transport belt 65. The fixing device 50 allows the medium S with unfixed color component images to pass through the fixing area FR between the fixing belt 51 and the pressure roll 52, and fixes the color component images to the medium S by a heating and pressurization process.

The medium S after completion of fixing becomes planer due to correction of curl (curve) by the curl correction device 80, and thereafter, the medium S is transported to the cooling device 90.

### <Processing by Cooling Device>

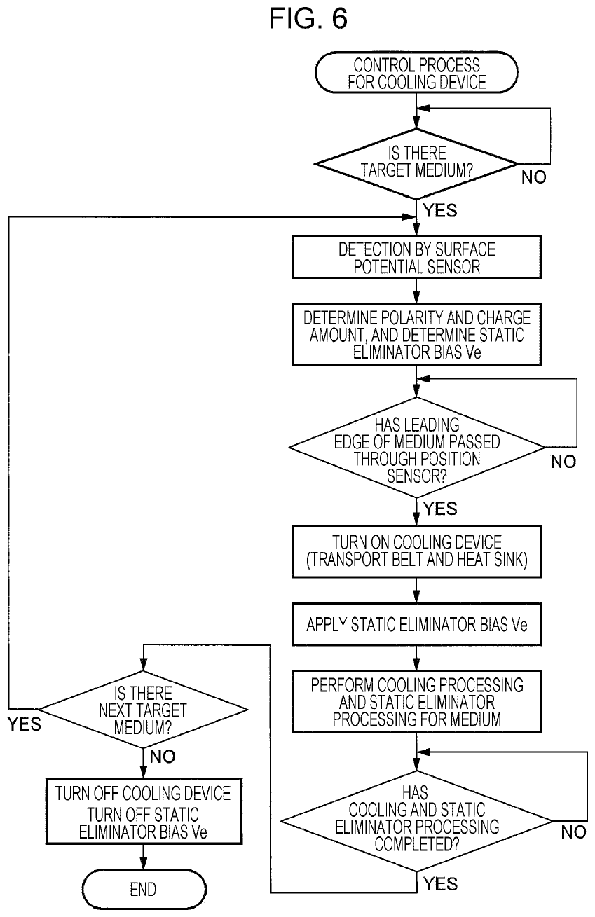

In this exemplary embodiment, the control device 160 controls the cooling device 90 according to the flowchart illustrated in FIG. 6.

First, the control device 160 checks whether there is a target medium S that is about to enter the cooling device 90 based on a detection signal from the position sensor 150.

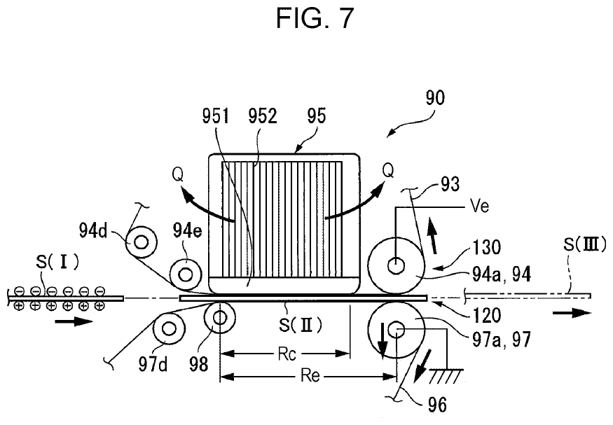

Suppose that there is a target medium S that is about to enter the cooling device 90, the surface potential sensor 151 detects the surface potential (polarity, charge amount) of the medium S. The control device 160 determines an effective static elimination bias Ve to eliminate the surface potential of the medium S based on a detection result of the surface potential sensor 151. In this situation, when a high resistance medium having a volume resistivity higher than or equal to a predetermined threshold (which is selected as appropriate in a range of e.g. 12 to 15 LogΩ·cm) is used as the medium S, as illustrated at S (I) in FIG. 7, if the front surface of the medium S is charged with e.g. negative polarity charges (−), the rear surface of the medium S is charged with positive polarity charges (+) by dielectric polarization, and the medium S enters the cooling device 90 still in a charged state.

When the leading edge of the medium S passes through the position sensor 150, the first transport belt 93, and the second transport belt 96 of the cooling device 90 are driven to rotate, and a suction operation for the heat sink 95 performed by the blower 105 starts.

Furthermore, the static elimination bias Ve is applied to the static elimination roller 131 of the static eliminator 130. In this example, as the static elimination power supply 135, the static elimination bias Ve (+) from the positive polarity power supply 137 is switched and selected.

In this state, the cooling process for the medium S and the static elimination process for the medium S are performed in the cooling device 90.

In this example, as illustrated in FIG. 7, in the cooling process for the medium S, when the medium S (II) enters the contact area Re between the first transport belt 93 and the second transport belt 96, the medium S is cooled using contact area Rc as the cooling area, the contact area Rc corresponding to a part of the contact area Re, where the heat sink 95 is in contact with the first transport belt 93. Specifically, the front surface (upper side of FIG. 7) of medium S (II) comes into contact with the first transport belt 93, and passes through the contact area Rc which is a cooling area. In this situation, the first transport belt 93 is directly cooled by the heat sink 95, and heat is radiated from the radiator plates 952 by the air flow from the blower 105 (see FIG. 4) in the heat sink 95, thus heat Q on the front surface of the medium S is released by the cooling effect of the first transport belt 93 and the heat radiation effect by the heat sink 95.

In contrast, the second transport belt 96 is not provided with the heat sink 95; however, when the medium S is not passed, the second transport belt 96 is in contact with the first transport belt 93, thus is indirectly cooled by the first transport belt 93 which is cooled by the heat sink 95. Therefore, heat Q on the rear surface of the medium S (II) is also indirectly cooled by the cooling effect of the second transport belt 96.

Note that in this example, the strength and air volume of the air flow from the blower 105 may be adjusted, and the degree of cooling by the heat sink 95 may be controlled by utilizing the information detected by the temperature sensor 152 serving as an environmental sensor. The static elimination operation on the medium S is performed in the following manner.

Specifically, when the first transport belt 93 is a conductive member, and the static elimination bias Ve is applied to the static elimination roller 131 as one of the pair, the first transport belt 93 is also in a state of being applied with the static elimination bias Ve. In addition, since the second transport belt 96 is also a conductive member, and the static elimination roller 132 as the other of the pair is grounded, the second transport belt 96 is also in a state of being grounded. In this state, when the medium S in a charged state enters the contact area Re between the first transport belt 93 and the second transport belt 96, in the contact area Re, negative polarity charges (−) on the front surface of the medium S are eliminated by reverse polarity charges of the first transport belt 93 to which the static elimination bias Ve (the positive polarity power supply 137 is selected in this example) has been applied, and positive polarity charges (+) on the rear surface of the medium S are released into the ground through the grounded second transport belt 96.

As a result, while passing through the contact area Re of the cooling device 90, the medium S undergoes static elimination while being cooled off. Thus, it is not possible for the medium S in a charged state to pass through the contact area Re, and there is no possibility that the medium S sticks to the first transport belt 93 or the second transport belt 96.

Meanwhile, it is known that scattering time of static electrical charge is given by electrical resistance x electrostatic capacitance.

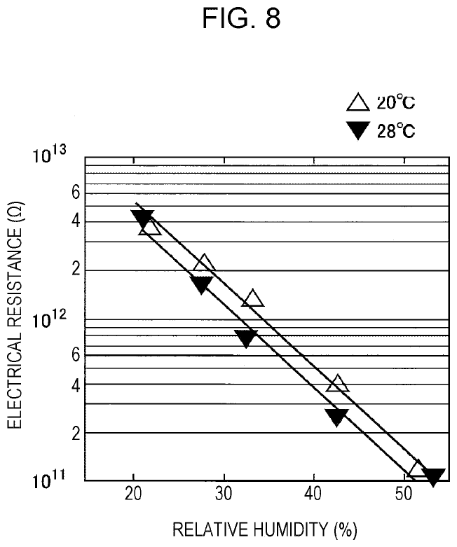

Study of the relationship between electrical resistance and relative humidity shows that the electrical resistance decreases exponentially as the relative humidity increases as illustrated in FIG. 8. In other words, as the relative humidity increases, the scattering time of static electrical charge is significantly reduced.

Thus, even with the same absolute humidity (the weight of water vapor contained in 1m3 air), as illustrated in FIG. 8, when the temperature drops, the relative humidity (the ratio of the amount of water vapor contained to the amount of saturated vapor per unit volume air at a certain temperature) increases. Thus, it is understood that static electrical charges are scattered in a short time.

In this manner, in this exemplary embodiment, the cooling device 90 performs the cooling process on the medium S along with the static elimination process, thus as compared to when the static elimination process is performed in a state where the cooling process is not performed, the static elimination process can be performed more quickly.

### Process after Passing through Cooling Device

When passing through the cooling device 90, medium S (III) with a fixed image on one side has undergone the cooling process and the static elimination process, and is transported to the ejection port 22 of the housing 21 for the horizontal transport path 64, and ejected by the ejection rollers 72 to a medium ejection receiver which is not illustrated.

Furthermore, as illustrated in FIG. 6, it is checked whether there is a next target medium S, and when there is a next target medium S, the cooling process and the static elimination process may be continuously performed by the cooling device 90. Meanwhile, when there is no next target medium S, the cooling device 90 may be turned off, and an operation of applying the static elimination bias Ve of the static eliminator 130 may also be turned off.

The case where a mode for forming an image on both sides of the medium S is performed will be described as follows. As described above, the medium S with a fixed image on one side is guided to the branch transport path 66 in the middle of the horizontal transport path 64, the guided medium S is reversed by the reverser 68, then returned to the vertical transport path 63 and the horizontal transport path 64 through the return transport path 69, and transported to second transfer arca TR again. Meanwhile, the image formers 30 (30a to 30d) form images composed of color component toner to be formed on the rear surface of the medium S, and first transfer the images onto the intermediate transfer body 41 of the transfer device 40, then rotate the intermediate transfer body 41 to move color component images to the second transfer area TR.

Subsequently, the color component images are secondly transferred to the rear surface of the medium S collectively by the second transfer unit 43.

Subsequently, as illustrated in FIG. 3, the medium S with the secondly transferred color component images reaches the fixing device 50 through the transport belt 65, and undergoes the fixing process in the fixing device 50. Subsequently, the medium S with an image fixed on both sides undergoes the curl correction process by the curl correction device 80, and the cooling process and the static elimination process by the cooling device 90, then is ejected through the ejection port 22 of the housing 21 to a medium ejection receiver which is not illustrated.

### Layout of Ejector of Cooling Device

### <Separation Discharge at Time of Medium Discharge>

In this exemplary embodiment, the medium S, which has passed through the contact area Re between the first transport belt 93 and the second transport belt 96, is ejected from the ejector 120 at the exit of the contact area Re. In this situation, because the ejector 120 also uses the static elimination rollers 131, 132 in a pair configuration included in the static eliminator 130, the static elimination bias Ve is applied to the static elimination roller 131.

In this state, when the medium S is ejected from the ejector 120, the medium S is separated from the first transport belt 93 or the second transport belt 96, and separation discharge tends to occur at the time of separation.

<Ejection Behavior of Medium from Cooling Device>

The ejection behavior of the medium S from the ejector 120 will be discussed.

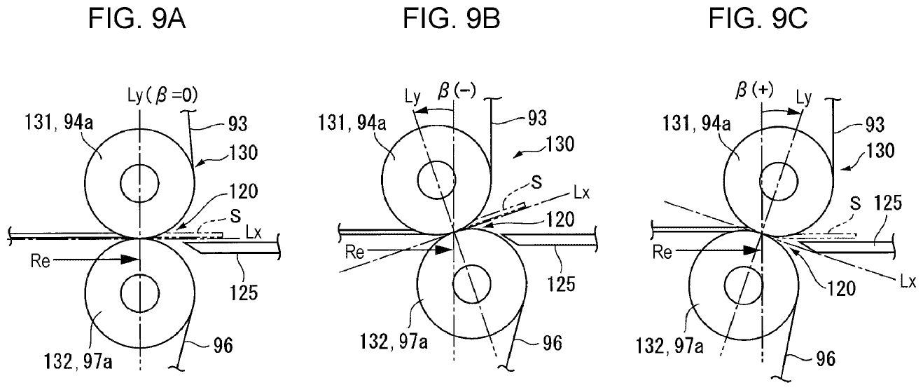

As illustrated in FIG. 9A, in the static elimination rollers 131, 132 in a pair configuration included in the ejector 120, let Ly be a reference line connecting the shaft centers, Lx be a perpendicular line which is orthogonal to the reference line Ly, and extends in the ejection direction of the medium S through the nip (clamper) of the static elimination rollers 131, 132 in a pair configuration.

In FIG. 9A, the reference line Ly has angle β of 0 with respect to the vertical line, and the perpendicular line Lx matches the horizontal line, and is located on an extension line from the contact area Re extending in a substantially horizontal direction. Thus, the leading edge of the medium S ejected from the ejector 120 tends to move in the direction of the perpendicular line Lx. However, when the medium S having a low bending rigidity is used, the leading edge of the medium S ejected from the ejector 120 may sag under its own weight, or may be charged with charges due to separation discharge and may stick to the first transport belt 93 or the second transport belt 96.

As illustrated in FIG. 9B, it is assumed that the reference line Ly is placed with an inclination of angle β(−) in a counterclockwise direction with respect to the vertical line. In this situation, the perpendicular line Lx is also inclined in a counterclockwise direction due to the inclination of the reference line Ly, thus the perpendicular line Lx is inclined diagonally upward by angle β(−) with respect to the horizontal line. Thus, the leading edge of the medium S, which has passed through the contact area Re, is ejected in the direction of the perpendicular line Lx when passing through the ejector 120. In this state, the leading edge of the medium S is slightly bent at the ejector 120, and accordingly, the bending rigidity of the medium S is increased. However, when the medium S having a low bending rigidity is used, the leading edge of the medium S ejected diagonally upward is in an unstable posture, thus may stick to the first transport belt 93 due to the effect of separation discharge mentioned above.

Furthermore, as illustrated in FIG. 9C, it is assumed that the reference line Ly is placed with an inclination of angle β(+) in a clockwise direction with respect to the vertical line. In this situation, the perpendicular line Lx is also inclined in a clockwise direction due to the inclination of the reference line Ly, thus the perpendicular line Lx is inclined diagonally downward by angle β(+) with respect to the horizontal line. Thus, the leading edge of the medium S, which has passed through the contact area Re, is ejected in the direction of the perpendicular line Lx when passing through the ejector 120. In this state, even if the medium S having a low bending rigidity is used, the leading edge of the medium S is slightly bent at the ejector 120, and butts against the guide chute 125 in a diagonally downward inclined posture, then is transported along the guide chute 125.

Thus, when the medium S having a low bending rigidity needs to be used, the layout illustrated in FIG. 9C may be adopted as the configuration of the ejector 120.

### SECOND EXEMPLARY EMBODIMENT

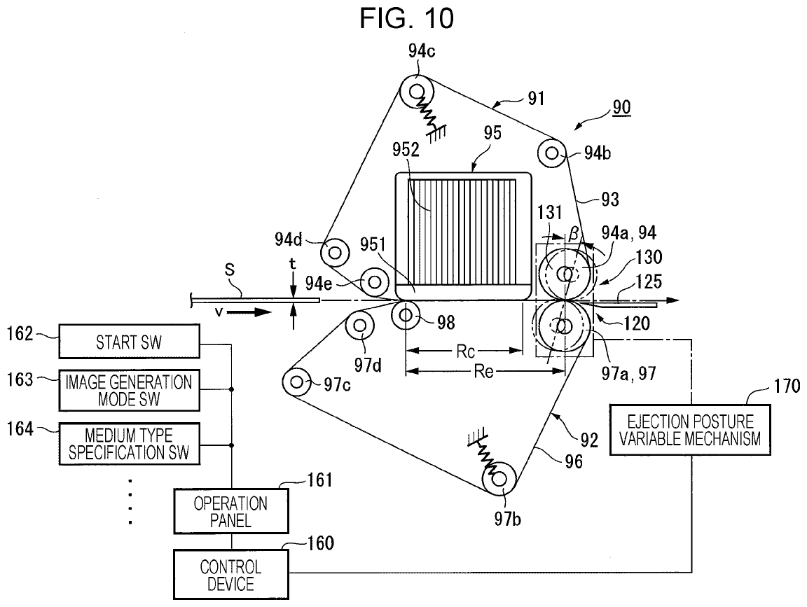

FIG. 10 is an explanatory view illustrating a primary part of a cooling device according to a second exemplary embodiment.

In FIG. 10, the basic configuration of the cooling device 90 is substantially the same as the configuration of the first exemplary embodiment, but further includes an ejection posture variable mechanism 170 serving as a variable ejection posture setter, which variably sets the ejection angle of the medium S ejected from the ejector 120 of the cooling device 90. Note that many of the same components as those in the first exemplary embodiment are omitted from illustration in FIG. 10, and the same components as those in the first exemplary embodiment are labeled with the same symbol, and a detailed description thereof is omitted.

In this example, the operation panel 161 of the control device 160 is provided with a medium type specification switch 164 to specify one of different medium types, in addition to a start switch 162 to start an image forming process for the medium S, and an image generation mode switch 163 to specify an image generation mode, such as single-sided printing, double-sided printing, or high-definition printing.

### Ejection Angle of Medium

In this exemplary embodiment, as illustrated in FIG. 10, the ejection angle θ of the medium S ejected from the ejector 120 of the cooling device 90 corresponds to the angle of inclination of the nip (clamper) of the static elimination rollers 131, 132 in a pair configuration included in the ejector 120 with respect to the horizontal line.

For example, as illustrated in FIG. 9A, the ejection angle θ of the medium S corresponds to the angle between the perpendicular line Lx orthogonal to the reference line Ly and the horizontal line, and this also corresponds to the angle β between the vertical line and the reference line Ly.

The layout illustrated in FIG. 9A in the case of β=0, the layout illustrated in FIG. 9B in the case of β=β(−), and the layout illustrated in FIG. 9C in the case of β=β(+) are implemented.

### Relationship between Medium Type and Ejection Angle of Medium

In this exemplary embodiment, the ejection angle θ of the medium S depends on the characteristic information (e.g., thickness t) of the medium S. Specifically, for the medium S having a large thickness t, the medium S has a high bending rigidity, thus the ejection posture of the medium S ejected from the ejector 120 is relatively stable. In contrast, for the medium S having a small thickness t, the medium S has a low bending rigidity, thus the ejection posture of the medium S ejected from the ejector 120 is likely to be unstable, and is easily affected by separation discharge.

It has been verified that even with the same medium type, when the feed velocity v of the medium S in the cooling device 90 varies, an appropriate ejection angle θ of the medium S varies.

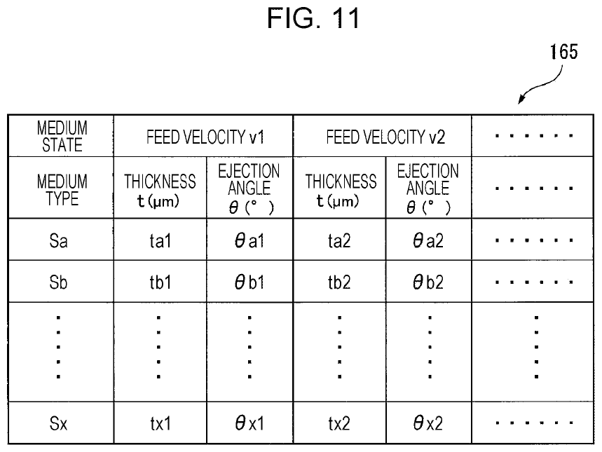

In this exemplary embodiment, as illustrated in FIG. 11, for medium type (Sa . . . Sx), combinations of thickness t (ta1 . . . tx1) as the characteristic information, and appropriate ejection angle θ of the medium S (θa1 . . . θx1, θa2 . . . θx2) for each feed velocity v (v1, v2 . . . ) of the cooling device 90 are verified by a demonstration experiment, and are to be stored in a RAM of the control device 160 as characteristics table 165.

### Ejection Posture Variable Mechanism

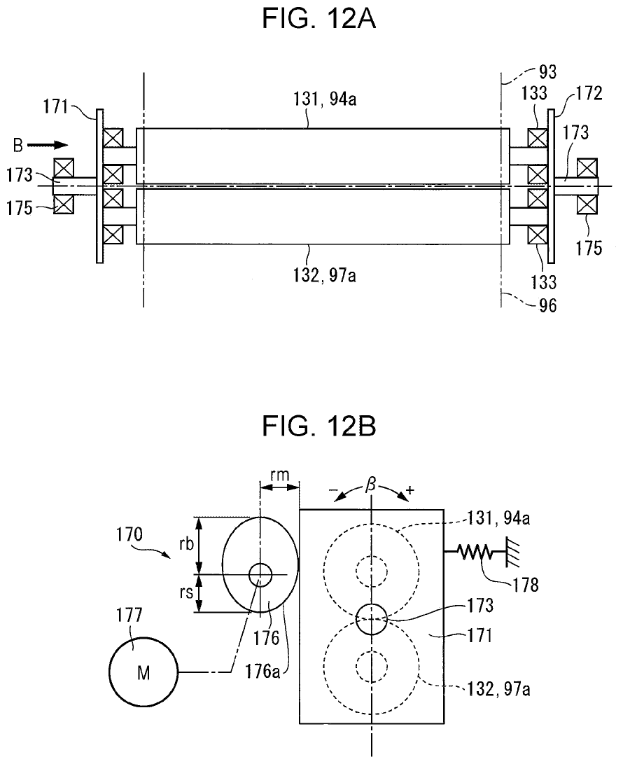

In this exemplary embodiment, as illustrated in FIG. 10 and FIGS. 12A and 12B, in the ejection posture variable mechanism 170, both end holders (bearings 133) of the static elimination rollers 131, 132 included in the ejector 120 are held by a pair of plate-like holders 171, 172, and the outer lateral surfaces of the holders 171, 172 is provided with a swing shaft 173 at a position corresponding to the nip of the static elimination rollers 131, 132 in a pair configuration, and the swing shaft 173 is swingably supported by a pair of bearings 175.

In this example, the static elimination rollers 131, 132 in a pair configuration are held by the pair of holders 171, 172 so as to maintain a relative positional relationship, and are designed to swing around the swing shaft 173 serving as a fulcrum.

In this example, in the ejection posture variable mechanism 170, one vertical side edge of one holder 171 is provided with an eccentric cam 176 so that the rollers 131, 132 are swingable around the swing shaft 173 serving as a fulcrum, the eccentric cam 176 is rotated by a drive motor 177, and the other vertical side edge located on the opposite side of the holder 171 with respect to the eccentric cam 176 is provided with a biasing spring 178 that biases the holder 171 toward the eccentric cam 176.

In this example, as illustrated in FIG. 12B, the eccentric cam 176 has a smooth cam surface 176a including a small diameter section rs, a medium diameter section rm, and a large diameter section rb, for example. In the eccentric cam 176, for example, when the medium diameter section rm is in contact with the holder 171, the reference line Ly of the static elimination rollers 131, 132 in a pair configuration is held in a vertical direction. When the small diameter section rs is in contact with the holder 171, the reference line Ly of the static elimination rollers 131, 132 in a pair configuration is to be held with an inclination of angle β(−) in a counterclockwise direction (−direction in FIG. 12B) with respect to the vertical line. Furthermore, when the large diameter section rb is in contact with the holder 171, the reference line Ly of the static elimination rollers 131, 132 in a pair configuration is to be held with an inclination of angle β(+) in a clockwise direction (+direction in FIG. 12B) with respect to the vertical line.

Note that the eccentric cam 176 can be brought into contact with the holder 171 at any point on the cam surface 176a including the small diameter section rs, the medium diameter section rm, and the large diameter section rb by adjusting the rotational position of the eccentric cam 176.

According to this exemplary embodiment, for example, when the medium type to be used is specified by the medium type specification switch 164, the control device 160 refers to the characteristics table 165 illustrated in FIG. 11 to determine the ejection angle θ of the medium S based on the feed velocity v of the cooling device 90.

Subsequently, the control device 160 transmits a control signal related to the determined ejection angle information on the medium S to the drive motor 177 of the ejection posture variable mechanism 170. As a result, the ejection posture variable mechanism 170 rotates the eccentric cam 176 as appropriate based on the control signal to adjust the position of the reference line Ly (or the perpendicular line Lx) of the static elimination rollers 131, 132 in a pair configuration. As a result, the ejection angle θ of the medium S ejected from the ejector 120 is set.

Note that in this exemplary embodiment, the characteristic information (thickness t) on the medium S uses what is specified by the medium type specification switch 164; however, without being limited to this, a thickness sensor may be provided in the middle of the medium transport system 60, and the thickness t of the medium S may be directly detected by the thickness sensor.

### THIRD EXEMPLARY EMBODIMENT

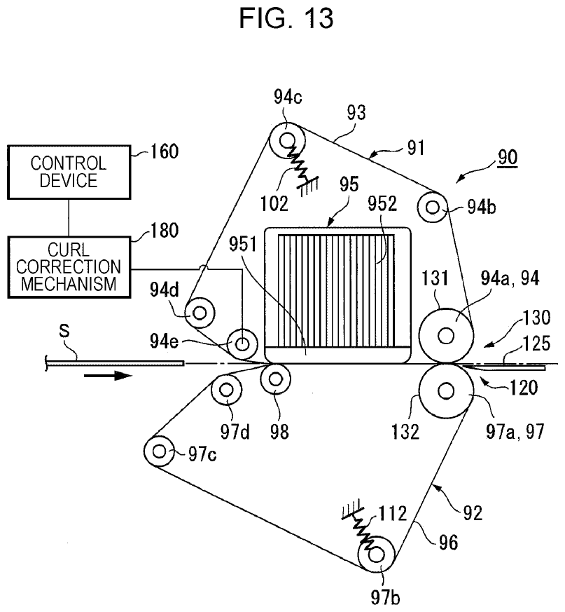

FIG. 13 is an explanatory view illustrating a primary part of a cooling device according to a third exemplary embodiment.

In FIG. 13, the basic configuration of the cooling device 90 is substantially the same as the configuration of the first exemplary embodiment, but further includes a curl correction mechanism 180 that can correct curl of the medium S. Note that many of the same components as those in the first exemplary embodiment are omitted from illustration in FIG. 13, and the same components as those in the first exemplary embodiment are labeled with the same symbol, and a detailed description thereof is omitted.

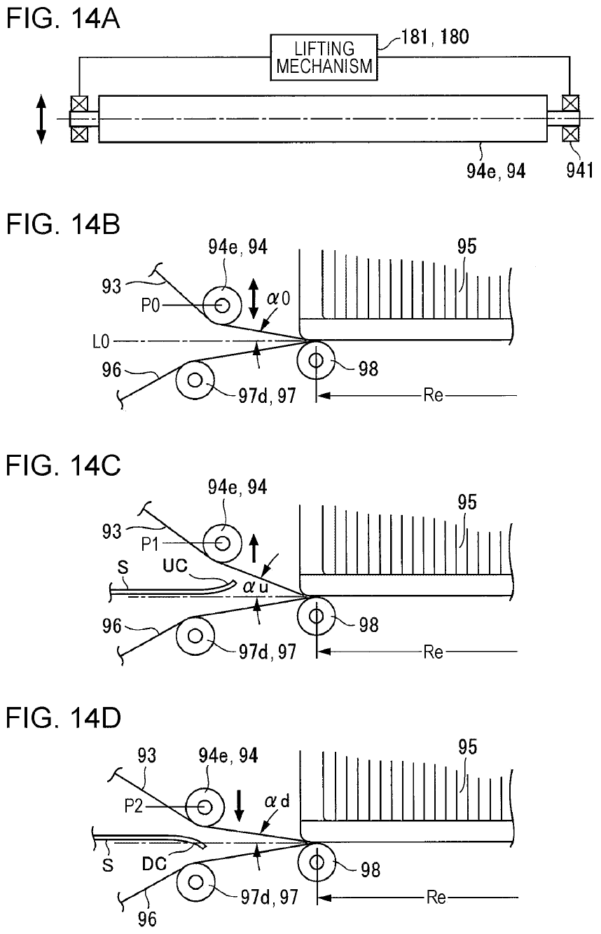

In this example, as illustrated in FIG. 14A, in the curl correction mechanism 180, both end holders (bearings 941) of the stretching roller 94e of the upper unit 91 of the cooling device 90 are liftably supported by a lifting mechanism 181.

The stretching roller 94e stretches a part of the first transport belt 93, the part being in front of the entry to the contact area Re. The stretching roller 94e is liftably supported by the lifting mechanism 181 in the vertical direction.

Now, it is assumed that the stretching roller 94e is set at a predetermined initial position P0 as illustrated in FIG. 14B.
Let L0 be the transport trajectory of the medium S which enters the control device 160, then crossing angle α between a belt area and the transport trajectory L0 of the medium S is set to α0, the belt area being between the entry to the contact area Re of the first transport belt 93 and the stretching roller 94c.
Next, in an aspect in which the leading edge of the medium S has an upper curl section UC, for example, as illustrated in FIG. 14C, the stretching roller 94e is raised to a predetermined position P1 above the initial position P0, and the crossing angle α may be set to αu (αu>α0). In this situation, an entry shape leading to the contact area Re of the first transport belt 93 is retracted above the initial position P0. Thus, an entry space leading to the contact area Re of the first transport belt 93 is expanded, and the medium S having the upper curl section UC is stably guided to the contact area Re of the cooling device 90. Consequently, the upper curl section UC of the medium S is corrected while passing through the contact area Re.

In an aspect in which the leading edge of the medium S has a down curl section DC, for example, as illustrated in FIG. 14D, the stretching roller 94e is lowered to a predetermined position P2 below the initial position P0, and the crossing angle α may be set to αd (αd<α0). In this situation, an entry shape leading to the contact area Re of the first transport belt 93 is advanced below the initial position P0. Thus, an entry space leading to the contact area Re of the first transport belt 93 is contracted, and the medium S having the down curl section DC is stably guided to the contact area Re of the cooling device 90. Consequently, the down curl section DC of the medium S is corrected while passing through the contact area Rc.

According to this exemplary embodiment, the cooling device 90 further performs the curl correction process. Thus, when the cooling device 90 according to this exemplary embodiment is used, the curl correction device 80 illustrated in FIG. 3 may be omitted.

### FOURTH EXEMPLARY EMBODIMENT

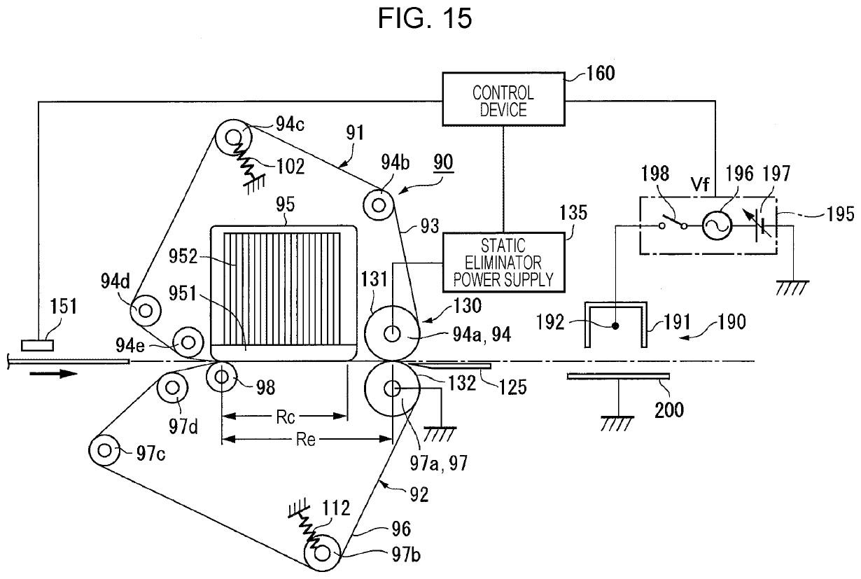

FIG. 15 illustrates a primary part of a cooling device according to a fourth exemplary embodiment.

In FIG. 15, the basic configuration of the cooling device 90 is substantially the same as the configuration of the first exemplary embodiment, but further includes a non-contact static elimination device 190 as a non-contact static eliminator that is disposed downstream of the static eliminator 130 of the cooling device 90 in the transport direction of the medium S. Note that many of the same components as those in the first exemplary embodiment are omitted from illustration in FIG. 15, and the same components as those in the first exemplary embodiment are labeled with the same symbol, and a detailed description thereof is omitted.

In this example, the non-contact static elimination device 190 includes a channel cross-sectional static elimination housing 191 which is open toward the front surface of the medium S transported along the horizontal transport path 64, a discharge wire 192 is passed over in the static elimination housing 191 in a longitudinal direction, and is coupled to a static elimination power supply 195.
The static elimination power supply 195 includes: an AC power supply 196 that outputs an AC voltage component; a DC power supply 197 that outputs an AC voltage component; and a switching device 198 that switches between power supply off and power supply on. The static elimination power supply 195 applies static elimination bias Vf consisting of AC voltage components on which DC voltage components can be superimposed as necessary, and a shoot member 200 comprised of a grounded metal plate is disposed under the rear surface of the medium S.

According to the exemplary embodiment, as in the first exemplary embodiment, the cooling device 90 performs the cooling process for the medium S and the static elimination process for the medium S.
Even if the static elimination process for the medium S is insufficient, the non-contact static elimination device 190 performs AC static elimination on the residual charges of the medium S at a downstream position of the cooling device 90 in the transport direction of the medium S, thus the static elimination level on the medium S is further reduced, and more equalized.

### EXAMPLE

### Example 1

This example is an implementation of the cooling device 90 according to the second exemplary embodiment.

In this example, the feed velocity v of the medium S in the cooling device 90 is set to 250 mm/s, 500 mm/s, and the relationship between thickness t of the medium S and appropriate ejection angle θ of the medium S has been demonstrated in an experiment in each velocity condition. Specifically, to determine appropriate ejection angle θ of the medium S referred to herein, when the medium S is ejected from the ejector 120 of the cooling device 90, it was observed whether a separation operation for the medium S was smoothly performed, and the medium S could be stably transported.

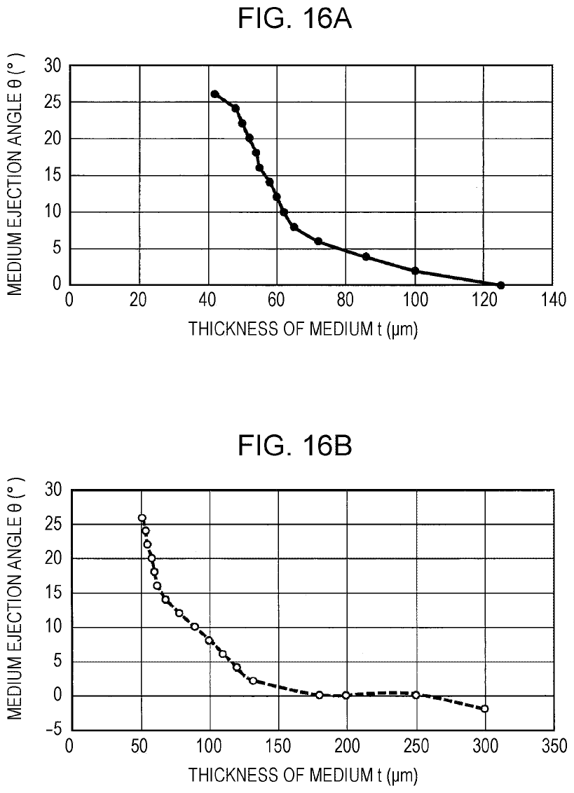

FIG. 16A illustrates a correlation between the thickness and ejection angle of the medium S when the feed velocity v=250 mm/s.

FIG. 16B illustrates a correlation between the both when the feed velocity v=500 mm/s.

According to FIGS. 16A and 16B, it has been verified that when the thickness t of the medium S is reduced, the ejection angle θ needs to be increased to +side (corresponding to the diagonally downward direction with respect to the horizontal line), otherwise a separation operation for the medium S is smoothly performed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1))) A medium transport device comprising:
a belt-shaped first transporter configured to come into contact with one surface of a medium, and transport the medium;
a belt-shaped second transporter configured to come into contact with the first transporter in an opposed manner, and transport the medium by nipping the medium in a contact area between the second transporter and the first transporter;
a cooler provided in at least one of the first transporter or the second transporter, and configured to cool the medium in the contact area; and
a static eliminator configured to eliminate static electricity of the medium which passes through the contact area, by applying a static elimination voltage to the first transporter or the second transporter.
(((2))) The medium transport device according to (((1))),
wherein the cooler is configured to cool a rear surface of the contact area between the first transporter or the second transporter.
(((3))) The medium transport device according to (((2))),
wherein the cooler is comprised of a heat radiator that is in contact with the rear surface of the contact area.
(((4))) The medium transport device according to any one of (((1))) to (((3))),
wherein the static eliminator is configured to apply a static elimination voltage to a part of a stretching member of the first transporter or the second transporter to apply the static elimination voltage to the first transporter or the second transporter.
(((5)) The medium transport device according to (((4))),
wherein the static eliminator uses a drive stretching member as the stretching member to which the static elimination voltage is applied.
(((6))) The medium transport device according to (((4))) or (((5))),
wherein as the stretching member to which the static elimination voltage is applied, the static eliminator uses a stretching member located at an exit of the contact area in a movement direction of the medium.
(((7))) The medium transport device according to any one of (((1))) to (((6))),
wherein the static eliminator is configured to variably set a polarity and an output value of the static elimination voltage.
(((8))) The medium transport device according to (((7))),
wherein the static eliminator includes a detector configured to detect a charge state of the medium before entering the contact area, and is configured to variably set a polarity and an output value of the static elimination voltage depending on a result of detection by the detector.
(((9))) The medium transport device according to (((7))) or (((8))),
wherein the static eliminator includes a determination unit that determines characteristic information of the medium before entering the contact area, and is configured to variably set a polarity and an output value of the static elimination voltage depending on a result of determination by the determination unit.
(((10))) The medium transport device according to any one of (((1))) to (((9))),
wherein the first transporter and the second transporter are comprised of a conductive member having a volume resistivity of 11 LogΩ·cm or lower in a voltage application condition of 500 V/thickness of 100 μ.
(((11))) The medium transport device according to any one of (((1))) to (((10))),
wherein in the first transporter and the second transporter, an entry shape leading to the contact area in a movement direction of the medium is deformed to a shape by which curl of the medium is correctable, and placed.
(((12))) The medium transport device according to any one of (((1))) to (((10))),
wherein the first transporter and the second transporter include an ejector comprised of a pair of stretching members at an exit of the contact area in a movement direction of the medium, and the ejector is provided with a variable ejection posture setter configured to variably set an ejection angle of the medium with respect to a predetermined reference line.
(((13))) The medium transport device according to (((12))),
wherein the variable ejection posture setter includes a determination unit that determines a type or characteristic information of the medium before entering the contact area, and is configured to variably set the ejection angle of the medium depending on a result of determination by the determination unit.
(((14))) The medium transport device according to any one of (((1))) to (((13))),
wherein the cooler includes a variable cooler configured to variably set a degree of cooling for the medium which passes through the contact area.
(((15))) The medium transport device according to any one of (((1))) to (((14))),
wherein the first transporter and the second transporter include a variable velocity setter configured to variably set a transport velocity of the medium which passes through the contact area.
(((16))) The medium transport device according to any one of (((1))) to (((15))), further comprising a non-contact static eliminator
that is provided downstream of an exit of the contact area in a transport direction of the medium, disposed in a non-contact state with the medium ejected from the contact area, and configured to further eliminate static electricity of the medium by corona discharge obtained by applying a discharge voltage to a discharge electrode, the discharge voltage including at least an alternating-current component.
(((17))) A medium processing system comprising:
a processing unit configured to perform a process associated with charging on a moving medium; and
the medium transport device according to any one of (((1))) to (((16))), which is provided downstream of the processing unit in a movement direction of the medium, and configured to cool the medium while eliminating static electricity of the medium by allowing the medium to pass through.
(((18))) The medium processing system according to (((17))),
wherein the processing unit includes an image generator configured to generate an image on an image carrier, and transfer the generated image to the medium using a transfer electric field; and a fixing unit configured to heat and fix the image transferred to the medium.

What is claimed is:

1. A medium transport device comprising:
a belt-shaped first transporter configured to come into contact with one surface of a medium, and transport the medium;
a belt-shaped second transporter configured to come into contact with the first transporter in an opposed manner, and transport the medium by nipping the medium in a contact area between the second transporter and the first transporter;
a cooler provided in at least one of the first transporter or the second transporter, and configured to cool the medium in the contact area; and
a static eliminator configured to eliminate static electricity of the medium which passes through the contact area, by applying a static elimination voltage to the first transporter or the second transporter.

2. The medium transport device according to claim 1,
wherein the cooler is configured to cool a rear surface of the contact area between the first transporter or the second transporter.

3. The medium transport device according to claim 2,
wherein the cooler is comprised of a heat radiator that is in contact with the rear surface of the contact area.

4. The medium transport device according to claim 1,
wherein the static eliminator is configured to apply a static elimination voltage to a part of a stretching member of the first transporter or the second transporter to apply the static elimination voltage to the first transporter or the second transporter.

5. The medium transport device according to claim 4,
wherein the static eliminator uses a drive stretching member as the stretching member to which the static elimination voltage is applied.

6. The medium transport device according to claim 4,
wherein as the stretching member to which the static elimination voltage is applied, the static eliminator uses a stretching member located at an exit of the contact area in a movement direction of the medium.

7. The medium transport device according to claim 1,
wherein the static eliminator is configured to variably set a polarity and an output value of the static elimination voltage.

8. The medium transport device according to claim 7,
wherein the static eliminator includes a detector configured to detect a charge state of the medium before entering the contact area, and is configured to variably set a polarity and an output value of the static elimination voltage depending on a result of detection by the detector.

9. The medium transport device according to claim 7,
wherein the static eliminator includes a determination unit that determines characteristic information of the medium before entering the contact area, and is configured to variably set a polarity and an output value of the static elimination voltage depending on a result of determination by the determination unit.

10. The medium transport device according to claim 1,
wherein the first transporter and the second transporter are comprised of a conductive member having a volume resistivity of 11 LogΩ·cm or lower in a voltage application condition of 500 V/thickness of 100 μm.

11. The medium transport device according to claim 1,
wherein in the first transporter and the second transporter, an entry shape leading to the contact area in a movement direction of the medium is deformed to a shape by which curl of the medium is correctable, and placed.

12. The medium transport device according to claim 1,
wherein the first transporter and the second transporter include an ejector comprised of a pair of stretching members at an exit of the contact area in a movement direction of the medium, and the ejector is provided with a variable ejection posture setter configured to variably set an ejection angle of the medium with respect to a predetermined reference line.

13. The medium transport device according to claim 12,
wherein the variable ejection posture setter includes a determination unit that determines a type or characteristic information of the medium before entering the contact area, and is configured to variably set the ejection angle of the medium depending on a result of determination by the determination unit.

14. The medium transport device according to claim 1,
wherein the cooler includes a variable cooler configured to variably set a degree of cooling for the medium which passes through the contact area.

15. The medium transport device according to claim 1,
wherein the first transporter and the second transporter include a variable velocity setter configured to variably set a transport velocity of the medium which passes through the contact area.

16. The medium transport device according to claim 1, further comprising a non-contact static eliminator
that is provided downstream of an exit of the contact area in a transport direction of the medium, disposed in a non-contact state with the medium ejected from the contact area, and configured to further eliminate static electricity of the medium by corona discharge obtained by applying a discharge voltage to a discharge electrode, the discharge voltage including at least an alternating-current component.

17. A medium processing system comprising:
a processing unit configured to perform a process associated with charging on a moving medium; and
the medium transport device according to claim 1, which is provided downstream of the processing unit in a movement direction of the medium, and configured to cool the medium while eliminating static electricity of the medium by allowing the medium to pass through.

18. A medium processing system comprising:
a processing unit configured to perform a process associated with charging on a moving medium; and
the medium transport device according to claim 2, which is provided downstream of the processing unit in a movement direction of the medium, and configured to cool the medium while eliminating static electricity of the medium by allowing the medium to pass through.

19. A medium processing system comprising:
a processing unit configured to perform a process associated with charging on a moving medium; and
the medium transport device according to claim 3, which is provided downstream of the processing unit in a movement direction of the medium, and configured to cool the medium while eliminating static electricity of the medium by allowing the medium to pass through.

20. The medium processing system according to claim 17,
wherein the processing unit includes an image generator configured to generate an image on an image carrier, and transfer the generated image to the medium using a transfer electric field; and a fixing unit configured to heat and fix the image transferred to the medium.
